(19) United States
(12) Patent Application Publication
(10) Pub. No.: US 2009/0105390 A1
(43) Pub. Date: Apr. 23, 2009

(54) USE OF CARBOXYLATE-CONTAINING POLYMERS AS ADDITIVES IN CERAMIC MATERIALS

(75) Inventors: Marcus Guzmann, Muhlhausen (DE); Thorsen Wiedemann, Bobenheim (DE); Stefan Becker, Mannheim (DE); Marco Schmidt, Speyer (DE); Thomas Gotz, Leimersheim (DE); Gregor Brodt, Heppenheim (DE); Joachim Pakusch, Speyer (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/995,613

(22) PCT Filed: Jul. 4, 2006
(86) PCT No.: PCT/EP2006/063832

§ 371 Date: Jul. 18, 2008

(30) Foreign Application Priority Data
Jul. 14, 2005 (DE) 102005033518.7

(51) Int. Cl. C08K 9/06; C08L 31/02

(52) U.S. Cl. 524/445; 524/558

(57) ABSTRACT

The present invention relates to the use of homopolymers or copolymers of (meth)acrylic acid or copolymers of C₃-C₄₀-monoolefins with ethylenically unsaturated C₄-C₆-dicarboxylic anhydrides as additives in ceramic masses, in particular in brick earth and clay for producing building ceramics such as bricks and roofing tiles, and also ceramic masses comprising these additives.

The present invention relates to the use of homopolymers or copolymers of (meth)acrylic acid or copolymers of C₃-C₄₀-monoolefins with ethylenically unsaturated C₄-C₆-dicarboxylic anhydrides as additives in ceramic masses, in particular in brick earth and clay for producing building ceramics such as bricks and rooting tiles, and also ceramic masses comprising these additives.

The production of bricks from brick earth is practiced worldwide. All processes involve quarrying of suitable brick earth or clay, crushing and/or milling the brick earth or clay to a suitable size and mixing the material with sufficient water to allow plastic processing of the brick earth or clay.

Brick earth is an earth mineral aggregate which consists predominantly of water-comprising aluminum silicates which are plastically deformable in the wet state, rigid in the dry state and vitrify on heating.

Clay is a clastic sediment consisting of a mixture of various minerals which is composed predominantly of clay minerals, aluminum hydrosilicates and hydrates, quartz, feldspar, mica, etc. Clay minerals are mainly kaolinite, halloysite, montmorillonite, illite and chlorite. Clay is plastically deformable in the wet state, rigid in the dry state and vitrifies on heating.

The brick earth or clay is quarried when it occurs and is transported to a brickworks for further processing to produce bricks.

In processing, water is, if appropriate, firstly added to adjust the moisture content or to increase the plasticity, and the clay/brick earth its then temporarily stored to allow it to swell. In further processing, the raw material is then milled to achieve a small particle size, in general preferably less than 1 mm. A moisture content of, for example, 20% is subsequently set by means of water so that the material becomes plastically processable. Additives or the polymers used according to the invention can also be added in this step. The polymers used according to the invention lead to increased plasticity and also increased mechanical strength of the dried products. The clay to which the additives have been added is subsequently extruded so as to shape it. This is followed by drying at temperatures above 100° C. If appropriate, an engobe or coating is subsequently applied to the shaped bodies. Firing is then carried out at temperatures of up to 1100° C. After firing, the finished products are cooled.

WO 01/09058 discloses a mixture comprising clay, water and a tannin or a tannin derivative and a method of producing bricks using the mixture claimed.

JP 10-194844 describes the production of shaped ceramic bodies comprising brick earth together with cement using maleic acid copolymers.

U.S. Pat. No. 3,061,564 discloses graft polymers based on shellac and acrylic monomers,

U.S. Pat. No. 4,148,662 and GB 2041950 disclose a mixture for producing bricks and a method of producing bricks using water-soluble anionic polyelectrolytes.

In practical brick production from brick earth or clay, the water content is a critical parameter. If the water content is too high, this can lead to deformation of the bricks during stacking, to long drying times and to undesirable shrinkage during drying. Furthermore, the mechanical stability of the dried products is relatively low, so that damage occurs easily and the reject rate is therefore increased.

On the other hand, if the water content is too low, the plastic processability is insufficient, which makes shaping impossible or can lead to crumbling of the bricks during further processing. An additive which when added in a small amount is able to significantly reduce the amount of water needed to enable the brick earth to be plastically processed can lead to considerable energy, time and cost savings and, by increasing the mechanical stability of the dried shaped bodies, to a reduction in rejects in the production of shaped parts.

It was therefore an object of the present invention to reduce the water required by clay or brick earth to enable it to be plastically processed and to increase the mechanical strength of the dried shaped body.

According to the invention, this object is achieved by the use of

(a) (meth)acrylic acid copolymers comprising
(i) from 50 to 100% by weight of a poly(meth)acrylic acid backbone and
(ii) 0-40% by weight of at least one unit which is selected from the group consisting of isobutene units, terelactone units and isopropanol units and is bound to the backbone and/or incorporated into the backbone and
(iii) from 0 to 50% by weight of units comprising sulfonic acid groups, and
(iv) if appropriate, further units which can be derived from ethylenically unsaturated monomers, with the total weight of the units in the (meth)acrylic acid copolymer being 100% by weight, or
   (b) copolymers of
(i) C₃-C₄₀-monoolefins with
(ii) ethylenically unsaturated C₄-C₆-dicarboxylic anhydrides
   as additives in ceramic masses, in particular in brick earth and clay for producing building ceramics such as bricks and roofing tiles.

The invention further provides ceramic masses comprising these additives, in particular brick earth and clay bricks comprising these additives.

For the purposes of the present invention, the term (meth)acrylic acid copolymers refers to methacrylic acid polymers, acrylic acid polymers and mixed polymers of methacrylic acid and acrylic acid. In a preferred embodiment of the invention, the polymer used according to the invention comprises a polyacrylic acid backbone.

For the purposes of the present invention, terelactone units are units having the following structure:

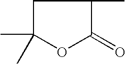

Homopolymers of acrylic acid and of methacrylic acid are known. They are prepared, for example, by polymerization of acrylic acid or methacrylic acid in aqueous solution in the presence of polymerization initiators and, if appropriate, polymerization regulators at temperatures of from 50 to 150° C. At temperatures above 100° C., it is necessary to carry out the polymerization in pressure apparatuses.

The molecular weights of the polyacrylic acids and polymethacrylic acids to be used according to the invention range from 500 to 100 000 g/mol and are preferably in the range from 80 to 40 000 g/mol.

Copolymers of acrylic acid and methacrylic acid, which can comprise the two monomers in any ratio, can likewise be used according to the invention. The molecular weight range of the copolymers of acrylic acid and methacylic acid corresponds to that of the homopolymers.

The weight average molecular weight is here determined by gel permeation chromatography (GPO) at room temperature in aqueous eluents.

If appropriate, the polymers (a) used according to the invention can further comprise units (iv) of other ethylenically unsaturated monomers which can be copolymerized with (meth)acrylic acid. Monomers suitable for this purpose are, for example, monoethylenically unsaturated carboxylic acids such as maleic acid, fumaric acid, itaconic acid, mesaconic acid, methylenemalonic acid and citraconic acid. Further copolymerizable monomers are C₁-C₄-alkyl esters of monoethylenically unsaturated carboxylic acids, e.g. methyl acrylate, ethyl acrylate, methyl methacrylate, ethyl methacrylate, hydroxyethyl acrylate, hydroxyethyl methacrylate, hydroxypropyl acrylate, hydroxypropyl methacrylate and hydroxybutyl acrylate. Suitable monomers also include alkylpolyethylene glycol (meth)acrylates derived from polyalkylene glycols having from 2 to 50 ethylene glycol units, monoallyl ethers derived from polyethylene glycols having from 2 to 50 ethylene glycol units and allyl alcohol. Further suitable monomers are acrylamide, methacrylamide, N-vinylformamide, styrene, acrylonitrile, methacrylonitrile and/or monomers bearing sulfonic acid groups and also vinyl acetate, vinyl propionate, allyl phosphonate, N-vinylpyrrolidone, N-vinylcaprolactam, N-vinylimidazole, N-vinyl-2-methylimidazoline, diallyldimethylammonium chloride, dimethylaminoethyl acrylate, diethylaminoethyl acrylate, dimethylaminoethyl methacrylate and diethylaminoethyl methacrylate. The basic monomers such as dimethylaminoethyl methacrylate can, for example, be used as comonomers in the form of the free bases, as salts with strong acids such as hydrochloric acid, sulfuric acid, or phosphoric acid or in the form of quaternized compounds. The abovementioned monomers comprising acid groups can likewise be used in the form of the free acids or as salts, for example the sodium, potassium or ammonium salts, in the polymerization. The polymers used according to the invention are preferably present in neutralized form.

Sulfonic acid monomers or salts thereof can likewise be copolymerized directly. The sulfonic acid monomers are preferably selected from the group consisting of 2-acrylamidomethyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 3-sulfopropyl methacrylate, sulfomethylacrylamide, sulfomethylmethacrylamide and their water-soluble salts.

The (meth)acrylic acid copolymer used according to the invention can have at least one unit selected from the group consisting of isobutene units, terelactone units and isopropanol units bound to the poly(meth)acrylic acid backbone.

It isobutene units are comprised in the polymer used according to the invention, they are present in an amount of, for example, from 0.5 to 3.0 mol %. In further embodiments, the amount of isobutene units present can be from 0.8 to 2.5 mol % or from 1.0 to 2.0 mol %.

The terelactone units can be present either at the end of the polymer chain or in the polymer chain.

The (meth)acrylic acid copolymers used according to the invention can further comprise at least one of the following structural units:

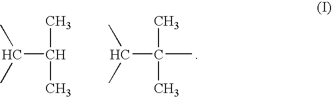

The amide units based on aminoalkylsulfonic acids can be derived from any aminoalkylsulfonic acid, Particularly useful aminoalkylsulfonic acids are those having from 2 to 12, preferably from 4 to 10, carbon atoms. The amino groups can be primary, secondary or tertiary. As further substituents, the aminoalkylsulfonic acids can bear, for example, hydroxy or alkoxy groups or halogen atoms. The alkyl groups can be unsaturated or preferably saturated, linear or branched or be closed to form a ring. The amino groups can be located within the chain of the aminoalkyl groups or be present as lateral or terminal substituents. They can also be part of a preferably saturated heterocyclic ring.

In a further embodiment of the present invention, the (meth)acrylic acid copolymer used according to the invention comprises the structural unit (II) based on aminoethanesulfonic acid (taurine):

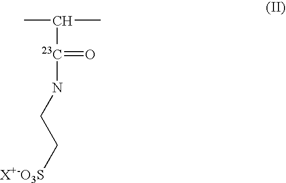

In general, the sulfonate radicals of the (meth)acrylic acid copolymers can be balanced by any counterion. The counterion is preferably selected from the group consisting of protons, alkali metal ions and ammonium ions.

The sulfoalkylamide structural units are preferably distributed randomly in the (meth)acrylic acid copolymer.

If the polymers (a) used according to the invention comprise the groups (i) and (iii) (polymer A) or (ii) and (iii) (polymer B), they are prepared by means of the following process steps:
(1) free-radical polymerization of (meth)acrylic acid in water in the presence of (i) and (iii) or in the presence of (ii) and (iii) in the additional presence of isopropanol or isopropanol and water, and
   amidation of the polymer A formed in process step (1) by reaction with at least one aminoalkanesulfonic acid.

This process is suitable, for example, for preparing the above-described (meth)acrylic acid copolymers used according to the invention.

Process step (1) is carried out at temperatures of preferably from 100 to 200° C., particularly preferably from 105 to 135° C., in particular from 120 to 125° C.

Process step (1) is preferably carried out in a closed reaction vessel, for example an autoclave. The pressure in process step (1) is thus generally determined by the vapor pressure (autogenous pressure) of water or, if appropriate, isopropanol or isopropanol/water mixtures at the abovementioned temperatures. Irrespective of this, the polymerization can, it appropriate, also be carried out with additional applied pressure or under reduced pressure.

Process step (1) can be carried out in isopropanol or in aqueous solutions comprising at least 20% by weight, particularly preferably at least 25% by weight, in particular at least 30% by weight, of isopropanol.

The free-radical polymerization of the monomers is preferably carried out using hydrogen peroxide as initiator. However, it is also possible to use any compounds which form free radicals under the reaction conditions, for example peroxides, hydroperoxides, peroxydisulfates, peroxydicarboxylic acids, peroxycarboxylic esters and/or azo compounds, as polymerization initiators.

If appropriate, further monomers, for example ethylenically unsaturated monomers which can be copolymerized with (meth)acrylic acid, can additionally be used in process step (1) of the process of the invention. Suitable comonomers are, for example, monoethylenically unsaturated carboxylic acids such as maleic acid, fumaric acid, itaconic acid, mesaconic acid, methylenemalonic acid and citraconic acid. Further copolymerizable monomers are C₁-C₄-alkyl esters of monoethylenically unsaturated carboxylic acids, e.g. methyl acrylate, ethyl acrylate, methyl methacrylate, ethyl methacrylate, hydroxyethyl acrylate, hydroxyethyl methacrylate, hydroxypropyl acrylate, hydroxypropyl methacrylate and hydroxybutyl acrylate. Suitable comonomers also include alkylpolyethylene glycol (meth)acrylates derived from polyalkylene glycols having from 2 to 50 ethylene glycol units, monoallyl ethers derived from polyethylene glycols having from 2 to 50 ethylene glycol units and allyl alcohol. Further suitable monomers are acrylamide, methacrylamide, N-vinylformamide, styrene, acrylonitrile, methacrylonitrile and/or monomers bearing sulfonic acid groups and also vinyl acetate, vinyl propionate, allyl phosphonate, N-vinylpyrrolidone, N-vinylcaprolactam, N-vinylimidazole, N-vinyl-2-methylimidazoline, diallyidimethylammonium chloride, dimethylaminoethyl acrylate, diethylaminoethyl acrylate, dimethylaminoethyl methacrylate and diethylaminoethyl methacrylate. The basic monomers such as dimethylaminoethyl-methacrylate can, for example, be used as comonomers in the form of the free bases, as salts with strong acids such as hydrochloric acid, sulfuric acid, or phosphoric acid or in the form of quaternized compounds. The abovementioned monomers comprising acid groups can likewise be used in the form of the free acids or as salts, for example the sodium, potassium or ammonium salts, in the polymerization.

In a particular embodiment of the present invention, the proportion of (meth)acrylic acid in the polymer B is from 75 to 95% by weight, preferably from 80% to 90% by weight, particularly preferably from 82.5 to 87.5% by weight. The proportion of units based on isopropanol in the polymer B is then preferably from 5 to 25% by weight, particularly preferably from 10 to 20% by weight, in particular from 12.5 to 17.5% by weight.

The polymer B which can be obtained by means of process step (1) of the process of the invention optionally comprises isobutene units in an amount of preferably from 0.5 to 3.0 mol %, particularly preferably from 0.8 to 2.5 mol %, in particular from 1.0 to 2.0 mol %. The isobutene units can, if appropriate, be located at the ends of the chain in the polymer B.

In a further embodiment of the present invention, the polymer B comprises terelactone units which are arranged at the ends of or within the polymer chain of the polymer B.

In a further embodiment of the present invention, the polymer B comprises both isobutene units and terelactone units.

The preparation process can preferably be carried out so that the (meth)acrylic acid copolymer has sulfonate groups with a counterion selected from the group consisting of protons, alkali metal ions and ammonium ions. However, the sulfonate radicals of the (meth)acrylic acid copolymers can generally be balanced by any counterion.

The polymers A and B which can be obtained by means of process step (1) are preferably comprised in a polymer solution which has a solids content of preferably from 10 to 70%, particularly preferably from 30 to 60%, in particular from 40 to 55%.

In a particular embodiment of the preparation process, the polymer solution comprising the polymer A and B is set to a pH of preferably from 2.0 to 9.0, particularly preferably from 4.0 to 7.5, in particular from 4.5 to 6.5, before the amidation of the polymer A and B in process step (2). All bases are in principle suitable for this purpose, but preference is given to aqueous solutions of alkali metal hydroxides, for example aqueous sodium hydroxide.

The amidation (process step (2)) is preferably carried out under a protective gas atmosphere, for example using argon or nitrogen.

Process step (2) of the preparation process is preferably carried out at temperatures of from 140 to 250° C., particularly preferably from 165 to 200° C., in particular from 175 to 185° C. The molar ratio of monomer units in polymers A and B to aminoalkanesulfonic acid is preferably from 15:1 to 2:1, particularly preferably from 11:1 to 3:1, in particular from 8:1 to 4:1. The pressure in process step (2) is preferably from 1 to 25 bar, particularly preferably from 5 to 17 bar, in particular from 7 to 13 bar.

The (meth)acrylic acid copolymer resulting from process step (1) preferably comprises at least one of the following structural units based on isopropanol:

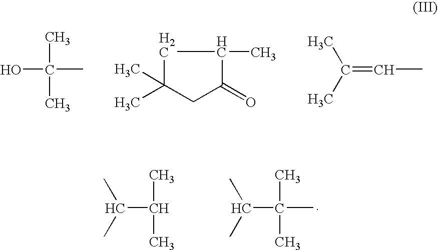

The (meth)acrylic acid copolymer which can be obtained by means of the preparation process particularly preferably comprises isobutene units and/or terelactone units. The isobutene units are preferably located at the ends of the chain in the (meth)acrylic acid copolymer, while the terelactone units can occur both at the end and within the polymer chain.

The formation of these different structural units can generally be effected according to the following reaction scheme (IV):

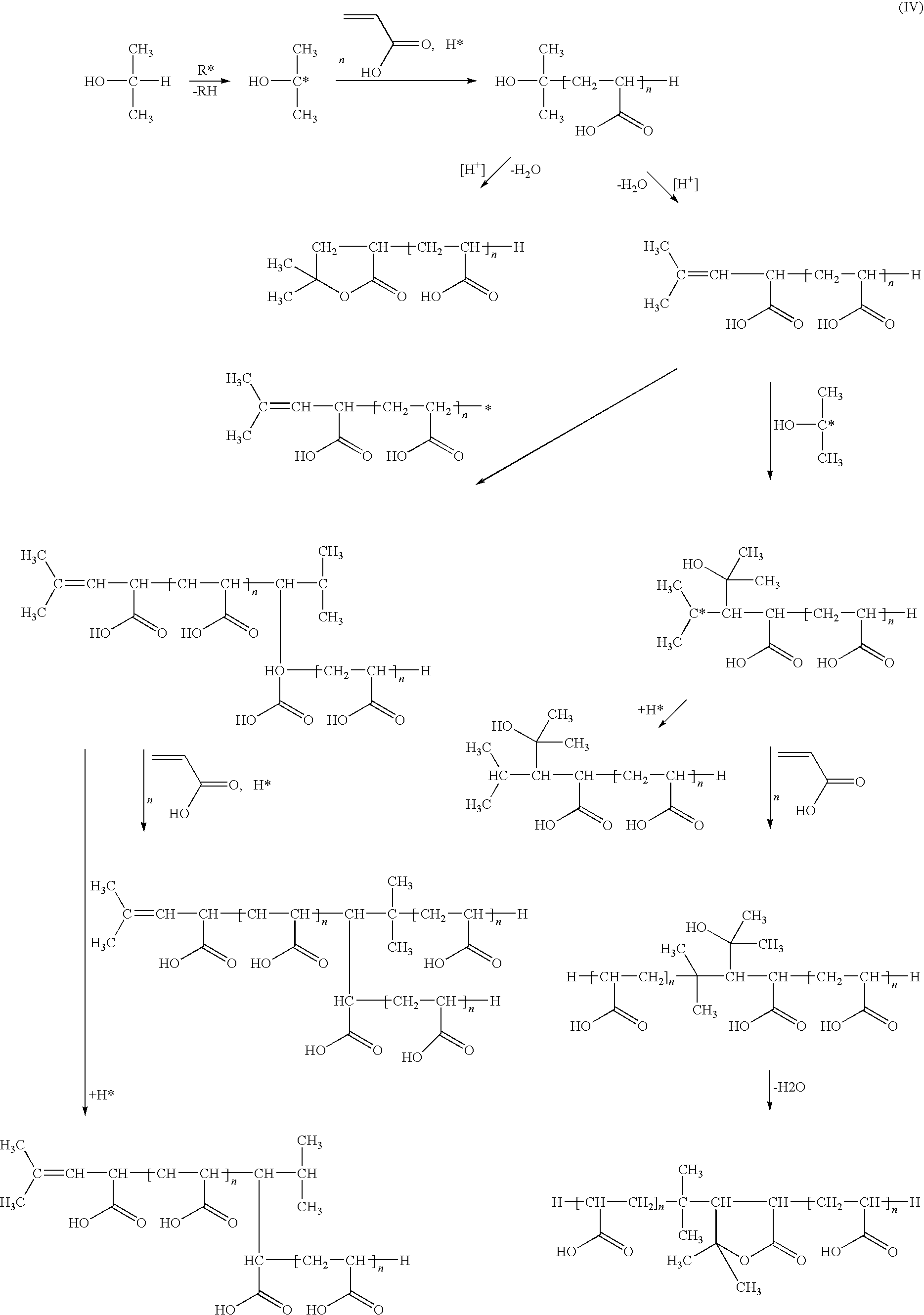

The (meth)acrylic acid copolymer B which can be obtained according to the invention preferably has a weight average molecular weight of from 500 to 20 000 g/mol, particularly preferably from 1000 to 15 000 g/mol, in particular from 1500 to 10 000 g/mol. The weight average molecular weight is determined by gel permeation chromatography (=GPC) at room temperature using aqueous eluents.

In a particular embodiment of the process of the invention, aminoethylsulfonic acid is used as aminoalkylsulfonic acid, so that the polymer resulting from process step (2) comprises units based on aminoethylsulfonic acid. However, any other aminoalkylsulfonic acids can also be used. In this respect, reference is made to what has been said above.

The copolymers (b) are known from, for example, DE-05 3 730 885. They are obtained in a bulk polymerization by copolymerization of the monomers of the group (i) with the monomers of the group (ii) at temperatures of from 80 to 300° C. Suitable monoolefins having from 3 to 40 carbon atoms are, for example, 2-propene, isobutene, n-oct-1-ene, 2,4,4-trimethyl-1-pentene, 2,4,4-trimethyl-2-pentene diisobutene which is industrially available as an isomer mixture of about 80% by weight of 2,4,4-trimethyl-1-pentene and about 20% by weight of 2,4,4-trimethyl-2-pentene, 4,4-dimethyl-1-hexene, 1-decene, 1-dodecene, 1-tetradecene, 1-hexadecene, 1-octadecene, C₂₀-1-olefin, C₂₂-1-olefin, C₂₄-1-olefin, C₂₀-C₂₄-1-olefin, C₂₄-C₂₆-1-olefin, C₃₅-1-olefin, C₃₀-1-olefin and C₄₀-1-olefin. The olefins or mixtures of olefins are commercial products. Apart from the straight-chain olefins, it is also possible to use cyclic olefins such as cyclooctene. The olefins can, due to their preparation, comprise small amounts of inert organic hydrocarbons, e.g. up to about 5% by weight. The olefins are usually used in the commercially available quality. They do not need to be subjected to any particular purification. The preferred olefins are alpha-olefins having chain lengths in the range from C4 to C 24. As component (ii) of the copolymers, it is possible to use monoethylenically unsaturated C₄-C₈-dicarboxylic anhydrides, e.g. maleic anhydride, itaconic anhydride, mesaconic anhydride, citraconic anhydride, methylenemalonic anhydride and mixtures of these. Among the anhydrides mentioned, preference is given to using maleic anhydride. The copolymers comprise from 40 to 60 mol % of monoolefins and from 60 to 40 mol % of the dicarboxylic anhydrides mentioned in copolymerized form and have a molar mass of from 500 to 20 000 g/mol, preferably from 800 to 12 000 g/mol. They can be obtained by polymerizing the monomers (i) and (ii) in a molar ratio of from 1.1:1 to 1:1. Preference is given to polymerizing the monomers (i) and (ii) in a molar ratio of 1:1 or using only a 1% by weight excess of monomers of the component (i). The monomers of the groups (i) and (ii) form, as is known, alternating copolymers which at high molecular weights comprise each of the monomers (i) and (ii) in an amount of 50 mol % in copolymerized form. At very low molecular weights of the copolymers, a deviation from this molar ratio within the abovementioned range can occur depending on the end groups, for example when the copolymer chain starts with the monomer (i) and also ends with the monomer (i).

The bulk polymerization is carried out at temperatures of from 80 to 300° C., preferably from 120 to 200° C., with the lowest polymerization temperature to be chosen preferably being at least about 20° C. above the glass transition temperature of the polymer formed. The polymerization conditions are chosen according to the molecular weight which the copolymers are to have. Polymerization at high temperatures gives copolymers having low molecular weights, while lower polymerization temperatures result in formation of polymers having higher molecular weights. The amount of polymerization initiator also has an influence on the molecular weight. In general, from 0.01 to 5% by weight, based on the monomers used in the polymerization, of free-radical-forming polymerization initiators is required. Higher amounts of initiator lead to copolymers having lower molecular weights. The monomers (i) and (ii) can also be copolymerized in the absence of polymerization initiators at temperatures above 200° C., i.e. use of initiators is not absolutely necessary because the monomers (i) and (ii) polymerize by a free-radical mechanism at temperatures above 200° C. even in the absence of initiators. Suitable polymerization initiators are, for example, di-tert-butyl peroxide, acetylcyclohexanesulfonyl peroxide, diacetyl peroxydicarbonate, dicyclohexyl peroxydicarbonate, di-2-ethylhexyl peroxydicarbonate, tert-butyl pemeodecanoate, 2,2′-azobis(4-methoxy-2,4-dimethylvaleronitrile), tert-butyl perpivalate, tert-butyl per-2-ethylhexanoate, tert-butyl permaleate, 2,2′-azobis(isobutyronitrile), bis(tert-butylperoxy)cyclohexane, tert-butyl peroxyisopropylcarbonate, tert-butyl peracetate, di-tert-butyl peroxide, di-tert-amyl peroxide, cumene hydroperoxide and tert-butyl hydroperoxide. The initiators can be employed either alone or in admixture with one another. In the bulk polymerization, they are preferably introduced into the polymerization reactor either separately or in the form of a solution or dispersion in the monoolefin. It is of course also possible to make concomitant use of redox coinitiators, e.g. benzoin, dimethylaniline, ascorbic acid and also organics-soluble complexes of heavy metals such as copper, cobalt, iron, manganese, nickel and chromium, in the copolymerization. The concomitant use of redox coinitiators allows the polymerization to be carried out at a lower temperature.

The customarily used amounts of redox coinitiators range from about 0.1 to 2000 ppm, preferably from 0.1 to 1000 ppm, based on the amounts of monomers used. If the monomer mixture starts to polymerize at the lower limit of the temperature range suitable for the polymerization and is subsequently fully polymerized at a higher temperature, it is advantageous to use at least two different initiators which decompose at different temperatures, so that a sufficient concentration of free radicals is available in each temperature interval.

To prepare low molecular weight polymers, it is often advantageous to carry out the copolymerization in the presence of regulators. It is possible to use customary regulators, for example C₁-C₄-aldehydes, formic acid and organic compounds comprising SH groups, e.g. 2-mercaptoethanol, 2-mercaptopropanol, mercaptoacetic acid, mercaptopropionic acid, tert-butyl mercaptan, n-dodecyl mercaptan and tert-dodecyl mercaptan, for this purpose. The polymerization regulators are generally used in amounts of from 0.1 to 10% by weight, based on the monomers.

The copolymerization is carried out in customary polymerization apparatuses, for example a pressure-rated vessel which is provided with a stirrer, in cascades of pressure-rated stirred vessels or in a tube reactor. In the bulk polymerization, the copolymerization of the olefins and the anhydrides occurs in the molar ratio set in the absence of solvents. The copolymerization can be carried out continuously or batchwise. For example, the olefin or a mixture of various olefins can be placed in the reactor and heated while stirring to the desired polymerization temperature. As soon as the olefin has attained the polymerization temperature, the ethylenically unsaturated dicarboxylic anhydride is fed in. If an initiator is used, it is metered into the reaction mixture, preferably separately or as a solution in an olefin employed in the polymerization. The polymerization regulator is, if it is used, added to the polymerizing mixture either separately or likewise as a solution in an olefin. The acid anhydrides, in particular maleic anhydride, are preferably added in the form of a melt to the reaction mixture. The temperature of the melt is from about 70 to 90° 0. If the olefin is used in excess in the copolymerization, e.g. in a 10% excess, it can be removed without difficulty from the reaction mixture, i.e. the copolymer melt, after completion of the copolymerization by means of a distillation, preferably under reduced pressure. It is advantageous for the copolymer melt subsequently to be directly processed further.

The copolymers prepared in this way are solvolyzed after cooling to room temperature or preferably in the form of a melt having a temperature in the range from 80 to 180° C., preferably from 90 to 150° C. The solvolysis of the anhydride groups of the copolymers comprises, in the simplest case, a hydrolysis and subsequent neutralization. It is particularly advantageous to carry out the solvolysis in pressure-rated apparatuses and in these convert the anhydride groups directly into carboxyl groups by addition of water to a melt of the copolymers obtainable in the bulk polymerization and neutralize at least 10% of the carboxyl groups of the hydrolyzed copolymers by subsequent addition of bases. However, hydrolysis and neutralization can also be carried out virtually simultaneously by addition of diluted aqueous bases to the copolymerization melt. The amounts of water and neutralizing agent are selected so that dispersions or solutions comprising from 10 to 60% by weight, preferably from 20 to 55% by weight, of solids are formed and can be marketed. Preparation solutions are then produced therefrom by dilution to solids contents of from 0.5 to 50% by weight.

The copolymers obtainable by bulk polymerization can also be solvolyzed by additional primary and/or secondary amines. The solvolysis is carried out using such amounts of amines that from 10 to 50% of the carboxyl groups which would be formed from the copolymerized monomers (ii) in a complete hydrolysis are amidated. After formation of monoamide groups in the copolymer, the neutralization is carried out. It is carried out to an extent such that at least 10% of the carboxyl groups of the copolymer formed in the bulk polymerization are neutralized. Furthermore, solvolysis can also be carried out using aminocarboxylic acids and salts of aminocarboxylic acids, preferably the alkali metal salts. Particular preference is given to using alkali metal salts of α-aminocarboxylic acids, with the alkali metal salts of sarcosine being very particularly advantageous. The solvolysis by means of salts of aminocarboxylic acids is advantageously carried out in an aqueous medium. The solvolysis is in this case carried out using such amounts of aminocarboxylates that from 10 to 50% of the total carboxyl groups which would be formed from the copolymerized monomers (ii) in a complete hydrolysis are amidated. After formation of monoamide groups in the copolymer, the neutralization is carried out. It is carried out to an extent such that at least 10% of the carboxyl groups of the copolymer formed in the bulk polymerization are neutralized.

The solvolysis can also be effected by addition of alcohols to a melt of the copolymers obtainable in the bulk polymerization. Use is in this case made of such amounts of alcohol that from 10 to 50% of the total carboxyl groups formed from the copolymerized dicarboxylic acid units are esterified. This is followed by a neutralization in which at least 10% of the total carboxyl groups formed from the copolymer comprising anhydride groups are neutralized.

Preference is given to from 25 to 50% of the total carboxyl groups formed from the copolymerized dicarboxylic anhydrides being amidated or esterified in each case. Suitable neutralizing agents are, for example, ammonium, amines, alkali metal bases and alkaline earth metal bases, e.g. sodium hydroxide, potassium hydroxide, magnesium hydroxide, calcium hydroxide, barium hydroxide and all amines which are also used for amidation of the copolymers. The neutralization is preferably effected by addition of aqueous sodium hydroxide to the copolymer. The neutralization of the copolymers comprising anhydride groups is carried out to at least such a degree that water-dispersible copolymers are obtained. This degree of neutralization is at least 10% of the total carboxyl groups formed from the anhydride groups. The degree of neutralization is also dependent on the chain length of the particular olefin used in the component (a). To obtain copolymers which are readily dispersible or colloidally soluble in water, a copolymer of a C₃₀-olefin and maleic anhydride is neutralized to an extent of at least 75%, while, for example, a copolymer of a C₂₀/C₂₄-olefin and maleic anhydride is readily dispersible in water when 50% of the carboxyl groups formed from this copolymer are neutralized. In the case of a copolymer of a C₁₂-olefin and maleic anhydride, neutralization of 20% of the carboxyl groups formed from the copolymerized maleic anhydride is sufficient for the copolymer to be able to be dispersed in water.

Ammonia and primary and secondary amines can be used for amide formation. Amide formation is preferably carried out in the absence of water by reaction of the anhydride groups of the copolymer with ammonia or the amines. The primary and secondary amines which come into question can have from 1 to 40, preferably from 3 to 30, carbon atoms. Suitable amines are, for example, methylamine, ethylamine, n-propylamine, isopropylamine, n-butylamine, isobutylamine, hexylamine, cyclohexylamine, methylcyclohexylamine, 2-ethylhexylamine, n-octylamine, isotridecylamine, tallow fatty amine, stearylamine, oleylamine, dimethylamine, diethylamine, di-n-propylamine, diisopropylamine, di-n-butylamine, diisobutylamine, dihexylamine, dicyclohexylamine, dimethylcyclohexylamine, di-2-ethylhexylamine, di-nsotylamine, diisotridecylamine, di-tallow fatty amine, distearylamine, dioleylamine, ethanolamine, diethanolamine, n-propanolamine, di-n-propanolamine and morpholine. Preference is given to using morpholine.

In order to achieve partial esterification of the copolymers comprising anhydride groups obtained in the bulk polymerization, they are reacted with alcohols. The esterification, too, is preferably carried out with exclusion of water. Suitable alcohols can have from 1 to 40, preferably from 3 to 30, carbon atoms. It is possible to use primary, secondary and tertiary alcohols. Either saturated aliphatic alcohols or unsaturated alcohols such as oleyl alcohol can be used. Preference is given to using monohydric. primary or secondary alcohols, e.g. methanol, ethanol, n-propanol, isopropanol, n-butanol, isobutanol, n-pentane and isomers, n-hexanol and isomers, n-octanol and isomers such as 2-ethylhexanol, nonanols, decanols, dodecanols, tridecanols, cyclohexanol, tallow fatty alcohol, stearyl alcohol and the alcohols or alcohol mixtures having from 9 to 19 carbon atoms which can readily be obtained industrially by the oxo process, e.g. C_{9/11} oxo alcohol, C_{12/15} oxo alcohol, and also Ziegler alcohols which are known under the name Alfol and have from 12 to 24 carbon atoms. Preference is given to using alcohols having from 4 to 24 carbon atoms, e.g. n-butanol, isobutanol, amyl alcohol, 2-ethylhexanol, tridecanol, tallow fatty alcohol, stearyl alcohol, C_{9/11} oxo alcohol, C_{12/15} oxo alcohol, C_{12/14} alfols and C_{16/18} alfols.

After the partial conversion of the anhydride groups into monoamide or monoester groups, hydrolysis of the anhydride groups still present in the copolymer is carried out. The hydrolysis of the remaining anhydride groups of the copolymer can also be carried out simultaneously with the partial neutralization still required by adding an aqueous base to the partially amidated or esterified copolymer which still comprises anhydride groups. The amount of water and base is selected so that the concentration of the copolymer dispersion or solution is preferably from 20 to 55% by weight. The pH of the ready-to-use composition is in the range from about 4 to 10.

For the purposes of the present invention, ceramic masses are, for example, building ceramics such as brick earth and clay bricks and roofing tiles (clay bricks, clay roofing tiles).

The additive to be used according to the invention can be added in the form of its aqueous solution in a simple fashion during the production process for the ceramic masses shortly before or during extrusion (injection into the extruder). It is added in amounts of from 0.01% to 5%, preferably from 0.1 to 1%, based on the solids content of the clay.

The additives used according to the invention can also be used in combination with further additives suitable for reducing the water requirement, for example tannins or tannin derivatives as described in WO 01/09058.

The percentages in the examples are, unless indicated otherwise, percentages by weight.

The molar masses of the copolymers are determined by gel permeation chromatography using tetrahydrofuran as eluent and narrow-distribution fractions of polystyrene for calibration.

### EXAMPLES

### Example 1

400.00 g of 2,4,4-trimethyl-1-pentene (α-diisobutylene) and 2.33 g of Lutonal® A50 (protective colloid) are placed in a 2 l glass reactor provided with an anchor stirrer, nitrogen inlet, internal thermometer, reflux condenser and dropping funnels. The initial charge is heated to 103° C. while flushing with nitrogen. The following feed streams were prepared:

Feed stream 1: 186.70 g of maleic anhydride (as melt in a beatable dropping funnel) Feed stream 2: 9.40 g of tert-butyl peroctoate dissolved in 70.60 g of 2,4,4-trimethyl-1-pentene

When the reaction temperature has been reached, 10% of the total amount of each of the two feed streams is firstly introduced all at once into the reactor while stirring and allowed to react for 15 minutes. The remaining amounts of the two feed streams are then added continuously starting at the same time, with feed stream 1 being added over a period of four hours and feed stream 2 being added over a period of five hours. After the addition is complete, the mixture is allowed to react further for 1 hour at 103° C. while continuing to stir.

Finally, 933.00 g of water are added to the reaction mixture, the reflux condenser is replaced by a distillation attachment and unreacted diisobutylene is distilled off. During the distillation, 182.90 g of 50% strength by weight aqueous sodium hydroxide solution are added.

This gives a yellowish, viscous polymer solution having a solids content of 25.2%, a pH of 9.7 and a K value of 44.0.

### Example 2

Sodium salt of a copolymer of methacrylic anhydride and isobutene, molar mass: 4000 g/mol, K value: 22, pH=7 (Sokalan® PM 10 l, BASF)

### Example 3

1.96 kg of maleic anhydride are placed in a vessel, the vessel is subsequently closed and made inert with nitrogen. 0.13 kg of a 20% strength solution of Lutonal® A (BASF) is subsequently added. After heating to 120° C., 0.784 kg of isobutene is introduced via feed stream 1 over a period of 5 hours. At the same time, 0.252 kg of C-18 alpha-olefin is introduced via feed stream 2 over a period of 3 hours. In parallel, 0.0831 kg of butyl peroctoate dissolved in 0.35 kg of o-xylene is fed in as feed stream 3 over a period of 5.5 hours. Polymerization is continued at 120° C. for a further period of about one hour. The mixture is cooled to 100° C., 3.1 kg of water are fed in and all of the xylene is subsequently replaced by water by means of a steam distillation using a distillation apparatus. 2.1 kg of 50% strength aqueous sodium hydroxide solution are subsequently added. The residual xylene is distilled off under reduced pressure. This gives a yellowish solution having a solids content of 39.9% and a K value of 21.5.

### Example 4

### Clay without Additive

### Example 5

250 g of water and 3.0 g of 50% strength phosphorous acid are placed in a 2 l reactor and heated under a nitrogen atmosphere to an internal temperature of 100° C. At this temperature, 517 g of acrylic acid are fed in via feed stream 1 over a period of 4 hours, 76.0 g of 7% strength sodium peroxodisulfate are simultaneously fed in via feed stream 2 over a period of 4.5 hours and 44.5 g of mercaptoethanol are simultaneously fed in via feed stream 3 over a period of 3.75 hours. The mixture is then cooled to 80° C., 0.43 g of 2,2′-azobis(2-methylpropionamidine) dihydrochloride dissolved in 16.25 g of water is subsequently added as feed stream 4 over a period of 30 minutes and the polymerization is subsequently continued for 1 hour. 570 g of 50% strength aqueous sodium hydroxide solution are then fed in as feed stream 5 at 80-95° C. over a period of about 1 hour. At an internal temperature of 80° C., 16 g of hydrogen peroxide solution (50% strength) are subsequently added over a period of 30 minutes and the mixture is stirred for a further 4 hours.

This gives a colorless polymer solution, pH=7.2, having a solids content of 49% and a K value of 20.

### Example 6

250 g of water and 3.0 g of 50% strength phosphorous acid are placed in a 2 l reactor and heated under a nitrogen atmosphere to an internal temperature of 100° C. At this temperature, 517 g of acrylic acid are fed in via feed stream 1 over a period of 4 hours, 76.0 g of 7% strength sodium peroxodisulfate are simultaneously fed in via feed stream 2 over a period of 4.5 hours and 44.5 g of mercaptoethanol are simultaneously fed in via feed stream 3 over a period of 3.75 hours. The mixture is then cooled to 80° C. 0.43 g of 2,2′-azobis(2-methylpropionamidine) dihydrochloride dissolved in 16.25 g of water is subsequently added as feed stream 4 over a period of 30 minutes and the polymerization is subsequently continued for 1 hour. About 110 g of 50% strength aqueous sodium hydroxide solution are then fed in as feed stream 5 at 80-95° C. over a period of about 1 hour, so that a pH of 4 is set. At an internal temperature of 80° C., 16 g of hydrogen peroxide solution (50% strength) are subsequently added over a period of 30 minutes and the mixture is stirred for a further 4 hours.

This gives a colorless polymer solution, pH=7.2, having a solids content of 48.5% and a K value of 20.

### Example 7

200 g of water and 2.7 g of 50% strength phosphorous acid are placed in a 2 l reactor and heated under a nitrogen atmosphere to an internal temperature of 99° C. At this temperature, 428 g of acrylic acid are fed in via feed stream 1 over a period of 5 hours, 61.3 g of 7% strength sodium peroxodisulfate are simultaneously fed in via feed stream 2 over a period of 5.25 hours and 54 g of mercaptoethanol are simultaneously fed in via teed stream 3 over a period of 4.75 hours. The reaction mixture is then stirred at 99° C. for another 15 minutes and then cooled to 80° C. 0.87 g of 2,2′-azobis(2-methylpropionamidine) dihydrochloride dissolved in 15.3 g of water is subsequently added as feed stream 4 over a period of 30 minutes and the polymerization is subsequently continued for 1 hour. 475 g of 50% strength aqueous sodium hydroxide solution are then fed in as feed stream 5 at 80-95° C. over a period of about 1 hour. At an internal temperature of 80° C., 14 g of hydrogen peroxide solution (50% strength) are subsequently added over a period of 30 minutes.

This gives a colorless polymer solution, pH=7.2, having a solids content of 47.3% and a K value of 15.

### Example 8

300 g of water and 3.42 g of 50% strength phosphorous acid are placed in a 2 l reactor and heated under a nitrogen atmosphere to an internal temperature of 99° C. At this temperature, 571 g of acrylic acid dissolved in 100 g of water are fed in via feed stream 1 over a period of 4 hours, 5.71 g of sodium peroxodisulfate dissolved in 57 g of water are simultaneously fed in via feed stream 2 over a period of 4.5 hours and 28 g of mercaptoethanol are simultaneously fed in via feed stream 3 over a period of 3.75 hours. The mixture is then cooled to 80° C. 0.64 g of 2,2′-azobis(2-methylpropionamidine) dihydrochloride dissolved in 21 g of water is subsequently added as feed stream 4 over a period of 30 minutes and the polymerization is subsequently continued for 1 hour. 625 g of 50% strength aqueous sodium hydroxide solution are then fed in as feed stream 5 at 80-95° C. over a period of about 1 hour. At an internal temperature of 80° C., 6 g of hydrogen peroxide solution (50% strength) are subsequently added over a period of 30 minutes and the mixture is stirred for a further 4 hours.

This gives a colorless polymer solution, pH=7.2, having a solids content of 49% and a K value of 30.

### Example 9

Apparatus: Pressure vessel having a volume of 2.5 l, with anchor stirrer, 2 separate feed streams

48.29 g of deionized water, 344.19 g of isopropanol and 31.16 g of hydrogen peroxide solution (30% strength) are placed in the vessel. The vessel is made inert with nitrogen and, after equalizing the pressure, closed in a pressuretight manner. The vessel is heated to 120° C. while stirring (220 rpm). At 110° C., the feed streams are started. Feed stream 1 comprises 431.00 g of isopropanol and 745.50 g (10.35 mol) of acrylic acid. Feed stream 2 comprises 47.80 g of hydrogen peroxide solution (30% strength) and 127.17 g of deionized water. The feed streams are fed in separately from one another, feed stream 1 over a period of 6 hours and feed stream 2 over a period of 7 hours. The polymerization temperature is 120° C. After all of feed stream 2 has been fed in, the reaction mixture is cooled and drained.

In a 2 l HWS apparatus provided with anchor stirrer and distillation attachment, the isopropanol is removed by means of simple distillation. During the distillation, 341.26 g of deionized water are added. The pH is subsequently set to 4.5 by means of 50% strength aqueous sodium hydroxide solution and the product is diluted with a further 500 ml of water.

This gives an aqueous polymer solution having a pH of 4.5, a solids content of 44.3% (2 hours at 100° C. in a vacuum drying oven). The K value is 20.

### Example 10

In a pressure reactor provided with stirrer, nitrogen inlet, reflux condenser and metering facility, 150.0 g of distilled water and 2.17 g of 85% strength by weight phosphoric acid were heated to an internal temperature of 95° C. while passing in nitrogen and stirring. 375.4 g of acrylic acid (99.2 mol %), 63.6 g of a 50% strength by weight solution of ethoxylated allyl alcohol (16.6 mol of EO/mol) (0.8 mol %), 66.2 g of a 40% strength by weight aqueous sodium hydrogensulfite solution and a mixture of 11.50 g of sodium persulfate and 152.2 g of distilled water were then introduced continuously as four separate feed streams over periods of 4 hours, 4 hours, 4 hours and 4.25 hours, respectively. After stirring at 95° C. for a further one hour and cooling to 50° C., a pH of 6.7 was set by adding 50% strength by weight aqueous sodium hydroxide solution over a period of 1.5 hours. 2.12 g of a 50% strength by weight aqueous hydrogen peroxide solution were then introduced over a period of 30 minutes while maintaining a temperature of 50-60° C., The mixture was finally stirred for another 30 minutes at this temperature.

A polymer solution having a solids content of 47.3% by weight and a K value of 34.3 (measured at a pH of 7 in 1% strength by weight aqueous solution at 25° C.) was obtained.

### Example 11

An acrylic acid polymer is firstly prepared (process step (a)).

In a reactor provided with nitrogen inlet, reflux condenser and metering facility, a mixture of 394 g of distilled water and 5.6 g of phosphorous acid (50% strength), was heated to an internal temperature of 95° C. while passing in nitrogen and stirring. Subsequently, (1) 936 g of acrylic acid, (2) 280 g of sodium peroxodisulfate solution (10% strength) and (3) 210 g of a 40% strength by weight aqueous sodium hydrogensulfite solution were added continuously in parallel over period of 5 hours. After stirring at 95° C. for a further one hour, the reaction mixture was cooled to room temperature and set to a pH of 4.0 by addition of 169 g of 50% strength by weight aqueous sodium hydroxide solution.

A clear polymer solution having a solids content of 54% by weight and a K value of 25 (1% strength by weight aqueous solution, 25° C.) was obtained.
b) A mixture of 1000 g of the polymer solution from a) (solids content=50%) and 130.47 g of taurine (aminoethanesulfonic acid) is placed in a pressure-resistant reaction vessel provided with stirrer, nitrogen inlet, temperature sensor, pressure display and deaeration facility. 110 g of a 50% strength aqueous sodium hydroxide solution are added to this mixture. The apparatus is flushed three times with nitrogen and closed. The mixture is then heated to an internal temperature of 180° C. while stirring. A pressure of about 10 bar builds up as a result. The mixture is maintained at this temperature for 5 hours. The mixture is then cooled without depressurization. The apparatus is opened and the pH of the mixture is set to 7.2. A clear yellow solution having a solids content of 49.6% and a Kvalue of 14.6 (1% strength in 3% NaCl solution) is obtained.

### Example 12

790.11 g of water, 922.85 g of maleic anhydride, 4.6 mg of iron sulfate (FeSO₄×7H₂O) and 12.78 g of 50% strength phosphorous acid are placed in a 10 l pressure reactor and heated under a nitrogen atmosphere to an internal temperature of 130° C. At this temperature, 1117.86 g of acrylic acid dissolved in 788.93 g of water are fed in via feed stream 1 over a period of 4.5 hours and 309.43 g of hydrogen peroxide solution (50% strength) are simultaneously fed in via feed stream 2 over a period of 6 hours. The polymerization is subsequently continued for a further 1.5 hours at an internal temperature of 125° C. The mixture is then cooled to 80° C. 11.57 g of hydrogen peroxide solution (50% strength) and 50 g of water are subsequently introduced via feed stream 3 over a period of 15 minutes and the polymerization is subsequently continued for a further 3 hours.

This gives a colorless polymer solution, pH=1.5, having a solids content of 50% and a K value of 20.

The K values of the polymers were determined by the method of H. Fikentscher, Cellulose-Chemie, Volume 13, 48-64 and 71-74 (1932) in aqueous solution at a pH of 7, a temperature of 25° C. and a polymer concentration of the sodium salt of the polymers of 1% by weight.

Testing with Brick Earth

### Sample Preparation

A mixer having mixing blade conforming to DIN/EN 196 was used for mixing the test substances. Mixing was carried out by the method prescribed in DIN/EN 196, as follows:

Make-up water (400 ml), fluidizer and antifoam were placed in the mixer. 1 kg of brick earth (from Claytec) was added and the mixture was stirred at a low rotational speed for 90 seconds. The mixture was subsequently stirred for 90 seconds before it was stirred for another 60 seconds at high speed. The sample was introduced into the measurement vessel. To avoid inclusions of air, the measurement pot was briefly knocked by hand (3 blows) and then introduced into the measurement apparatus and fixed. The measurement was started by means of the software a total of 5:15 minutes after the commencement of mixing.

### Measurement:

A rheometer model UDS200 from Paar Physika was used for the measurements. As testing body, the ball measurement system KMS-2 was used.

Shear-rate-dependent measurements were carried out, i.e. the viscosity was determined as a function of the shear rate γ. An overview of the measurement profile selected is shown in Table 1.

| Phase number | 1 | 2 | 3 |
|---|---|---|---|
| Duration of phase | 5 s | 5 min. | |
| Number of measure- | 2 | 2 | 20 |
| ment points | (discarded) | (discarded) | |
| Measurement point | | | 20 . . . 0.2 s |
| duration | | | (log) |
| Condition | n = 1 min⁻¹ | γ = 0 | γ = 10⁻³ . . . 10² |
| | | | s⁻¹ (log) |

Since the ball leaves a channel on dipping into the sample, a short phase (phase 1) which moves the ball away from the point of entry was inserted. A rest phase (phase 2) was inserted after this in order to allow any structures destroyed by the entry and movement in phase 1 to be reestablished.

As comparative examples:

D3 brick, Humin Products

All products were measured in the concentrations 0.025%, 0.05, 0.1, 0.15% and 0.2%.

The results are shown in the following table:

Viscosities (in Pa s)

| | Shear rate: 1.22 [s⁻¹] | | | | | Shear rate: 57.5 [s⁻¹] | | | | |
|---|---|---|---|---|---|---|---|---|---|---|
| Polymer add. [%] * | 0.025 | 0.05 | 0.10 | 0.15 | 0.20 | 0.025 | 0.05 | 0.10 | 0.15 | 0.20 |
| Example 1 | 311 | 268 | 194 | 157 | 179 | 7.02 | 5.85 | 4.52 | 4.21 | 5.06 |
| Example 2 | 331 | 258 | 130 | 45.8 | 33.0 | 7.22 | 5.73 | 3.33 | 2.12 | 1.80 |
| Example 3 | 334 | 257 | 172 | 43.7 | 26.0 | 7.44 | 5.62 | 3.70 | 2.00 | 1.72 |
| Humin ® P118 ** | 497 | 465 | 431 | 331 | 337 | 10.1 | 9.95 | 8.97 | 7.10 | 7.49 |
| Humin ® S775 ** | 546 | 536 | 475 | 367 | 399 | 10.5 | 10.8 | 10.2 | 7.89 | 8.81 |
| Humin ® P775 ** | 452 | 442 | 421 | 191 | 187 | 9.20 | 9.18 | 8.82 | 4.30 | 4.34 |
| Orfom ® D3 tannin *** | 404 | 391 | 282 | 252 | 208 | 8.76 | 8.54 | 6.70 | 6.09 | 5.28 |

* Mass of polymer (solid) based on mass of dry brick earth
** from Humintech GmbH Düsseldorf
*** from Chevron Phillips Chemical Company LP

Use Tests on Clay

The clay used for the experiments described below came from a mine at St. Géours de Maremne in France.

The extrusion tests were carried out using a laboratory extruder PZVMR 8d from Handle, Mühlacker, Germany.

5000 g of clay were in each case firstly mixed with the polymers in the kneader so that the polymer content was 0.2% by weight, based on the dry matter of the clays. Furthermore, a water content of 20.0% was set in the kneader by addition of water. The mixing time per batch was about 10 minutes. The moisture content was determined by IR spectroscopy using a Sartorius MA 30 at 130° C. with automatic switch-off.

As a measure of the plasticity, the torque of the extruder shaft and the radial pressure at the extruder head (die) were determined. The lower the torque and the pressure, the higher the plasticity of the clay to which the additive has been added.

It is surprisingly found that the addition of homopolyacrylates (Examples 5 to 8) having a molar mass in the range from 1200 to 8000 g/mol effects a significant reduction in the extruder torque and the pressure compared to clay to which no additive has been added (Example 4). The plasticity of the clay has thus been significantly increased by the addition of polymer.

Surprisingly, the addition of polymer results in a significant increase in the bending tensile strength (BTS) of the dried clay, even though the water content was identical. The copolymers too, effect an increase in the plasticity and also an increase in the BTS.

| | | Moisture | | | | | Bending |
|---|---|---|---|---|---|---|---|
| | | after | M_{w} of | | Torque of | Radial | tensile |
| | | extension | polymer | | extruder | pressure | strength |
| Ex. | Monomer building blocks | [%] | [g/mol] | pH | [Nm] | [bar] | [N/mm²] |
| 4 | | 19.4 | | | 200 | 12.7 | 8.0 |
| 5 | AA | 19.8 | 2500 | 8 | 145 | 9.0 | 9.7 |
| 6 | AA | 19.7 | 2500 | 4 | 165 | 10.5 | 9.4 |
| 7 | AA | 19.6 | 1200 | 8 | 130 | 9.0 | 10.3 |
| 8 | AA | 19.8 | 8000 | 8 | 130 | 10.0 | 10.6 |
| 9 | AA, hydrophobically mod. | 19.5 | 4000 | 8.5 | 175 | 11.0 | — |
| 10 | AA, allyl ether ethoxylate | 20.0 | 3000 | | 160 | 9.7 | 9.4 |
| 11 | AA, sulfonated | 19.9 | 3000 | 7.0 | 145 | 9.5 | 9.4 |
| 12 | AA, MA | 19.5 | 3000 | 1.5 | 175 | 10.7 | — |
| 1 | MA, DIB | 19.6 | 12 000 | 11 | 160 | 10.0 | 8.0 |
| 2 | MA, IB | 19.8 | 4000 | 7 | 170 | 10.5 | — |
| 3 | MA, IB, C18 olefin | 19.9 | 3000 | 9 | 160 | 9.7 | 9.4 |

AA = acrylic acid; MA = maleic anhydride; DIB = diisobutene; IB = isobutene

### Determination of the Bending Tensile Strength (BTS)

The BTS was determined on test bars having dimensions of 20 mm×15 mm×120 mm. The specimens were, after extrusion, dried under reduced pressure for about 72 hours and subsequently at 110° C. in a drying oven. The measurement was carried out subsequently using a TONITECHNIK testing apparatus using the 3-point bend method.

The addition of poly acrylates to clay allows the treatment via extender for producing moulded articles also in case of reduced water content. In contrast to that the specimens of clay to which no polymer has been added cannot be treated in the extruder at a moisture content of below 19.4%. The results are shown in the following. The polyacrylates were added in the respective experiment with 0.2% by weight based on the dry matter of the clay.

| | | Torgue | | | Pfefferkorn- | Bending |
|---|---|---|---|---|---|---|
| | Moisture after | of | Radical | Penetrom- | Compressing | tensile |
| | extension | extender | pressure | eter | height | strenght |
| Example | [%] | [Nm] | [bar] | [kg/inch²] | [mm] | [N/mm²] |
| 4 | 19.4 | 200 | 12.7 | 1.2 | 32.0 | 8.0 |
| 3 | 19.9 | 160 | 9.7 | 1.0 | 30.5 | 9.4 |
| | 18.8 | 210 | 13.6 | 1.4 | 32.5 | 9.4 |
| | 17.9 | 240 | 18.0 | 1.8 | 34.0 | 9.9 |
| 5 | 19.8 | 145 | 9.0 | 1.0 | 30.0 | 9.7 |
| | 18.5 | 190 | 13.4 | 1.4 | 32.5 | 10.0 |
| | 18.1 | 200 | 15.2 | 1.5 | 33.0 | 10.0 |
| | 17.2 | 220 | 17.0 | 1.7 | 33.5 | 9.7 |
| 6 | 19.7 | 165 | 10.5 | 1.2 | 31.5 | 9.4 |
| | 19.0 | 190 | 12.7 | 1.2 | 32.0 | 9.4 |
| | 18.0 | 250 | 17.5 | 1.9 | 34.0 | 10.1 |
| 7 | 19.6 | 130 | 9.0 | 0.9 | 30.0 | 10.3 |
| | 18.8 | 180 | 12.5 | 1.2 | 31.5 | 9.1 |
| | 18.0 | 230 | 17.0 | 1.5 | 33.0 | 9.7 |
| 8 | 19.8 | 130 | 10.0 | 1.0 | 31.0 | 10.6 |
| | 18.8 | 190 | 12.8 | 1.2 | 32.5 | 9.5 |
| | 17.8 | 230 | 17.2 | 1.7 | 34.0 | 9.6 |

1. A ceramic mass comprising:
(meth)acrylic acid copolymers comprising:
(i) from 50 to 100% by weight of a poly(meth)acrylic acid backbone,
(ii) 0-40% by weight of at least one unit which is selected from the group consisting of isobutene units, terelactone units and isopropanol units and is bound to the backbone and/or incorporated into the backbones and
(iii) from 0 to 50% by weight of units comprising sulfonic acid groups,
wherein the total weight of the units in the (meth)acrylic acid copolymer being 100% by weight, ands the ceramic mass is obtainable by adding the (meth)acrylic acid (co)polymers as additives in a form of their aqueous solution shortly before or during extrusion.

2. The ceramic mass according to claim 1,
wherein the ceramic masses are brick earth or clay.

3. The ceramic mass according to claim 1, wherein the additive is added in amounts of from 0.01 to 5% by weight.

4. The ceramic mass according to claim 1, wherein the molecular weight of the polymers (a) is from 500 to 100 000.

5. (canceled)

6. The ceramic mass according to claim 1, wherein homopolyacrylates are used.

7. The ceramic mass according to claim 1, wherein the ceramic masses are brick earth or clay roofing tiles or bricks.

8. (canceled)

9. A brick or roofing tile comprising
(meth)acrylic acid copolymers comprising
(i) from 50 to 100% by weight of a poly(meth)acrylic acid backbone,
(ii) 0-40% by weight of at least one unit which is selected from the group consisting of isobutene units, terelactone units and isopropanol units and is bound to the backbone and/or incorporated into the backbone, and
(iii) from 0 to 50% by weight of amide units based on aminoalkylsulfonic acids,
wherein the total weight of the units in the (meth)acrylic acid and (co)polymer being 100% by weight, and the ceramic mass is obtainable by adding the (meth)acrylic acid (co)polymers as additives in the form of their aqueous solution shortly before or during extrusion.

10. The brick or roofing tile according to claim 9, wherein the brick or roofing tile is a clay or brick earth brick or roofing tile.

11. A process for producing ceramic masses, comprising adding
(meth)acrylic acid copolymers comprising:
(i) from 50 to 100% by weight of a poly(meth)acrylic acid backbone,
(ii) 0-40% by weight of at least one unit which is selected from the group consisting of isobutene units, terelactone units and isopropanol units and is bound to the backbone and/or incorporated into the backbone, and
(iii) from 0 to 50% by weight of amide units based on aminoalkylsulfonic acids,
as an additive to a ceramic mass in a form of their aqueous solution shortly before or during extrusion,
wherein the total weight of the units in the (meth)acrylic acid copolymer is 100% by weight.

12. The process according to claim 11, wherein the ceramic mass is brick or clay.

13. The process according to claim 11, wherein the additive is added in amount of from 0.01 to 5% by weight.

14. The process according to claim 11, wherein the molecular weight of the polymers is from 500 to 100,000.

15. The process according to claim 11, wherein homopolyacrylates are used.

16. The process according to claim 11, wherein the ceramic masses are brick earth or clay roofing tillers or bricks.
